(19) United States
(12) Patent Application Publication
(10) Pub. No.: US 2026/0071520 A1
(43) Pub. Date: Mar. 12, 2026

(54) CHATBOT FOR DIGITAL PRODUCTS

(71) Applicant: Schlumberger Technology Corporation, Sugar Land, TX (US)

(72) Inventors: Monisha Manoharan, Menlo Park, CA (US); Jagan Mohan Gottimukkula, Menlo Park, CA (US); Salma Benslimane, Menlo Park, CA (US); Neelansh Garg, Menlo Park, CA (US); Sandeep Sekhar Bathala, Los Angeles, CA (US); Thomas Thurston, Menlo Park, CA (US); Aakarshan Dhakal, Menlo Park, CA (US); Advaya Gupta, Menlo Park, CA (US); Sai Shravani Sistla, Menlo Park, CA (US); Prateek Raj Srivastava, Menlo Park, CA (US); Apoorva Dubey, Menlo Park, CA (US); Celso Aguiar, Menlo Park, CA (US); Vineet Kamboj, Menlo Park, CA (US); Yifan Wang, Menlo Park, CA (US)

(21) Appl. No.: 19/327,674

(22) Filed: Sep. 12, 2025

Related U.S. Application Data
(60) Provisional application No. 63/694,132, filed on Sep. 12, 2024.

(51) Int. Cl. E21B 43/16; G06F 16/3329; G06F 16/334

(52) U.S. Cl. CPC E21B 43/16; G06F 16/33295; G06F 16/3347; E21B 2200/20; E21B 2200/22

(57) ABSTRACT

A method for generating a response to a user query includes receiving a user query that involves user query text and/or one or more user query images. The method also includes converting the user query into a contextualized query using a multimodal retrieval-augmented generation (RAG) agent. The method also includes retrieving paths from a vector database in response to the contextualized query. The method also includes retrieving contents from a storage in response to the paths. The method also includes generating an answer to the user query based upon the contents.

### CROSS-REFERENCE TO RELATED APPLICATIONS

This application claims priority to U.S. Provisional Pat. Application No. 63/694,132, filed on 12 Sep. 2024, which is incorporated by reference.

### BACKGROUND

Conventional chatbots exist to answer user queries. However, the conventional chatbots are not tailored to specific technology areas (e.g., the energy domain such as oil and gas). Accordingly, conventional chatbots may not be able to provide detailed answers in these technology areas. Therefore, what is needed is an improved system and method for answering queries related to digital products and services in specific technology areas (e.g., the energy domain).

### SUMMARY

A method for generating a response to a user query is disclosed. The method includes receiving a user query that involves user query text and/or one or more user query images. The method also includes converting the user query into a contextualized query using a multimodal retrieval-augmented generation (RAG) agent. The method also includes retrieving paths from a vector database in response to the contextualized query. The method also includes retrieving contents from a storage in response to the paths. The method also includes generating an answer to the user query based upon the contents.

A computing system is also disclosed. The computing system includes one or more processors and a memory system. The memory system includes one or more non-transitory computer-readable media storing instructions that, when executed by at least one of the one or more processors, cause the computing system to perform operations. The operations include receiving a user query. The user query involves user query text and/or one or more user query images. The user query is related to an energy domain. The operations also include converting the user query into a contextualized query using a multimodal retrieval-augmented generation (RAG) agent. The operations also include converting the one or more user query images into text using a large language model (LLM) or a custom vision language model (VLM). The operations also include combining the contextualized query and the text to produce a contextualized input text query. The operations also include retrieving paths from a vector database in response to the contextualized input text query. The paths include context paths of documents that are retrieved from a first portion of the vector database and/or image paths that are retrieved from a second portion of the vector database. The operations also include retrieving contents from a storage in response to the paths. The content includes context contents that are retrieved from a first portion of the storage and/or image contents that are retrieved from a second portion of the storage in response to the contextualized input text query. The context contents include information related to the user query. The operations also include generating an answer to the user query based upon the contents. The answer is generated using the multimodal RAG agent.

A non-transitory computer-readable medium is also disclosed. The medium includes instructions that, when executed by one or more processors of a computing system, cause the computing system to perform operations. The operations include receiving a user query. The user query involves user query text and one or more user query images. The user query is related to an energy domain. The operations also include determining that the user query is safe using a guardrail service. The operations also include converting the user query into a contextualized query using a multimodal retrieval-augmented generation (RAG) agent. The operations also include converting the one or more user query images into text using a large language model (LLM) or a custom vision language model (VLM). The operations also include combining the contextualized query and the text to produce a contextualized input text query. The operations also include retrieving paths from a vector database in response to the contextualized input text query. The paths include context paths of documents that are retrieved from a first portion of the vector database and image paths that are retrieved from a second portion of the vector database. Content for determining the image paths is created based upon documents in the vector database. The documents include one or more document images. The content for determining the image paths is created based upon: (1) text before and after one or more document images; (2) a caption corresponding to the one or more document images; and (3) a description of the one or more document images determined by a multimodal model. The operations also include retrieving contents from a storage in response to the paths. The content includes context contents that are retrieved from a first portion of the storage and image contents that are retrieved from a second portion of the storage in response to the contextualized input text query. The context contents include information related to the user query including a user manual training manuals and a user guide. The operations also include generating an answer to the user query based upon the contents. The answer is generated using the multimodal RAG agent.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates a flowchart of a method for generating a response to a user query in the energy domain, according to an embodiment.

FIG. 3 illustrates a schematic view of the method shown in FIG. 2, according to an embodiment.

FIGS. 4A-4E illustrate an answer to the user query “How do I set the zone settings for facies modelling in Petrel?,” according to an embodiment.

FIG. 5 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### System Overview

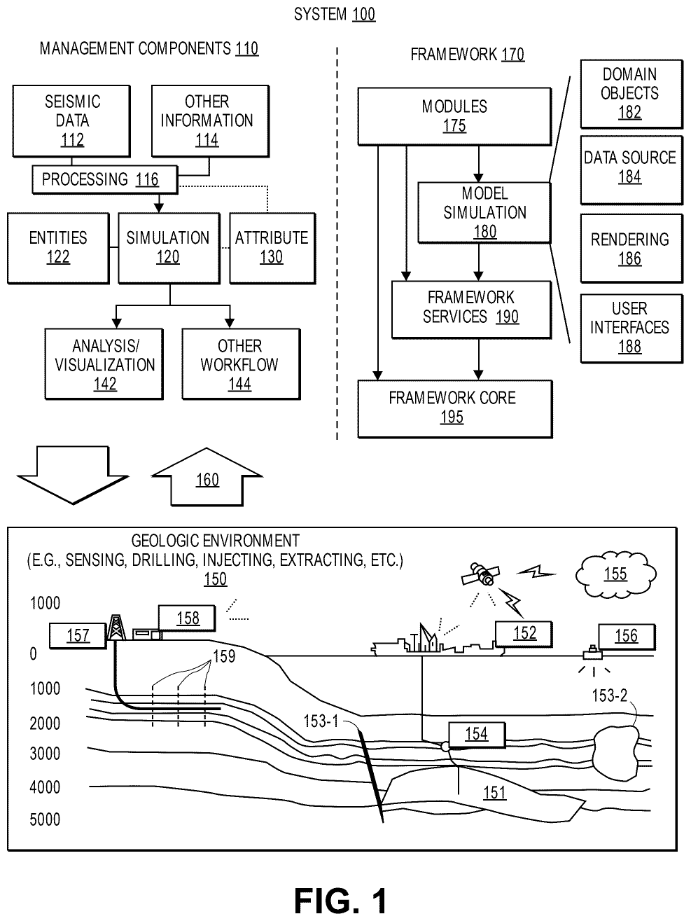

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

As an example, the simulation component 120 may include one or more features of a simulator such as SYMMETRY™ software (SLB, Houston, Texas). More particularly, SYMMETRY™ may process workflows in a single integrated environment with accurate thermodynamic fluid representation and consistent modeling across multiple disciplines including process, production, and HSE. The simulator integrates steady-state and transient (e.g., dynamic) analyses that can be tailored for each domain. This approach enables users to optimize processes in upstream, midstream, and downstream sectors while maximizing profits and minimizing capital expenditures. It may also help reduce emissions, energy consumption, and waste.

As an example, the simulation component 120 may include one or more features of a simulator such as PIPESIM™ (SLB, Houston, Texas). More particularly, PIPESIM™ M is steady-state multiphase flow simulator that incorporates the three areas of flow modeling: multiphase flow, heat transfer and fluid behavior.

As an example, the simulation component 120 may include one or more features of a simulator such as OLGA™ (SLB, Houston, Texas). More particularly, OLGA™ is a dynamic multiphase flow simulator that models transient flow (e.g., time-dependent behaviors) to maximize production potential. Transient modeling is a component for feasibility studies and field development design. Dynamic simulation is useful in deep water and is used in both offshore and onshore developments to investigate transient behavior in pipelines and wellbores. Transient simulation with the OLGA™ simulator provides an added dimension to steady-state analysis by predicting system dynamics, such as time-varying changes in flow rates, fluid compositions, temperature, solids deposition, and operational changes.

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages.NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

### Chatbot for Digital Products

The method described herein may perform data parsing. More particularly, custom data parsers may produce cleaned and processed data. This data may be or include prepared and organized multimodal data (e.g., text and images) for use. The data parsing may also include ingested data and created embeddings. For example, the multimodal data may be converted into embeddings, which may allow features to be captured from each modality. The data parsing may include a chunking strategy and data schema design. The embeddings may be stored in a vector database that is designed for efficient similarity searches for both raw text and image description.

The method may also include performing vector search and/or retrieval. This may include an embedded user query and semantic similarity search. For example, the user query may be transformed into embeddings and used to search for similar embeddings in the vector store, considering multiple modalities. Relevant data may also be retrieved. For example, extracted relevant multimodal data may be retrieved from the vector store based on the query.

The method may also include generation and/or synthesis. More particularly, injected retrieved data may be generated or synthesized into a prompt template. For example, the retrieved multimodal data may be incorporated into a prompt template as context, along with other user inputs. The prompt may be sent to a large language model (LLM). For example, the context-rich prompt may be submitted for synthesis and generation of the final response, integrating insights from multiple modalities.

The method may use a multimodal retrieval-augmented generation (RAG) agent. This may be or include a tool-calling methodology that is implemented with chat history and context maintained. Both image and text vector DBs may be used for retrieval and generation.

The method may implement guardrails. A custom domain-specific user input policy may be curated iteratively in collaboration with subject matter experts (SMEs). A LLM-based guardrail service may be developed by customizing an open-source framework.

The method may also include Evaluation and Benchmarking. This may include iterative development of domain benchmarks across different products in collaboration with SMEs using both manual ways and LLM auto-generated question answers. Classical metrics and/or LLM-based metrics may be used to evaluate the system iteratively and make improvements to the data processing, prompts, design of the system, etc.

The method may also include a chatbot application and prompt store. This may provide logging prompts, responses, latency, and feedback to the prompt store

Table 1 (below) shows a list of deliverables built during application development.

TABLE 1

| Deliverables | Implementations |
|---|---|
| Data processing | Generic unstructured data parser |
| PDF, XML, PPT to MD | Custom DITA XML Parser |
| Product does QA datasets (3 training/4 test) | |
| Multimodal RAG | Batch embeddings generation pipeline |
| Text | Vector DB ingestion pipelines (text and image) |
| Image | Product documentation vector DB collections |
| Product does data collections (3) | (shared embeddings) |
| | Retriever and generation APIs |
| | Agentic RAG |
| | Prompt store (logging and feedback) |
| | Custom guardrail service |
| Evaluation and benchmarking suite | Evaluator and LLM pipeline |
| Hit rate and MRR | Chunking and embedding pipelines (5 |
| Faithfulness | strategies) |
| Answer correctness | Retrieval benchmarking service (2 metrics) |
| Answer relevancy | Generation benchmarking service (9 metrics) |
| Context precision and recall | |
| Rouge scores - 1, 2, L, LSum | |
| Application | Ask AI engine |
| Front end and AI integration | |
| Load and stress testing | |
| Domain testing and updates | |

The method may provide some improvements over conventional methods, such as a custom data parser for DITA XML data, a multimodal RAG agent, domain guardrails, domain benchmarks, and domain system prompts. Accordingly, the system may provide benefits or advantages such as an in-built AI assistant, enhanced data discovery, automated knowledge base updates, better overall user chat experience, and enriched analysis and insight generation. Users may use the method to reference architecture for building domain chatbots. In addition, the domain benchmarks may be open source for the energy industry. Moreover, the domain guardrails can be a value add for any LLM-based system.

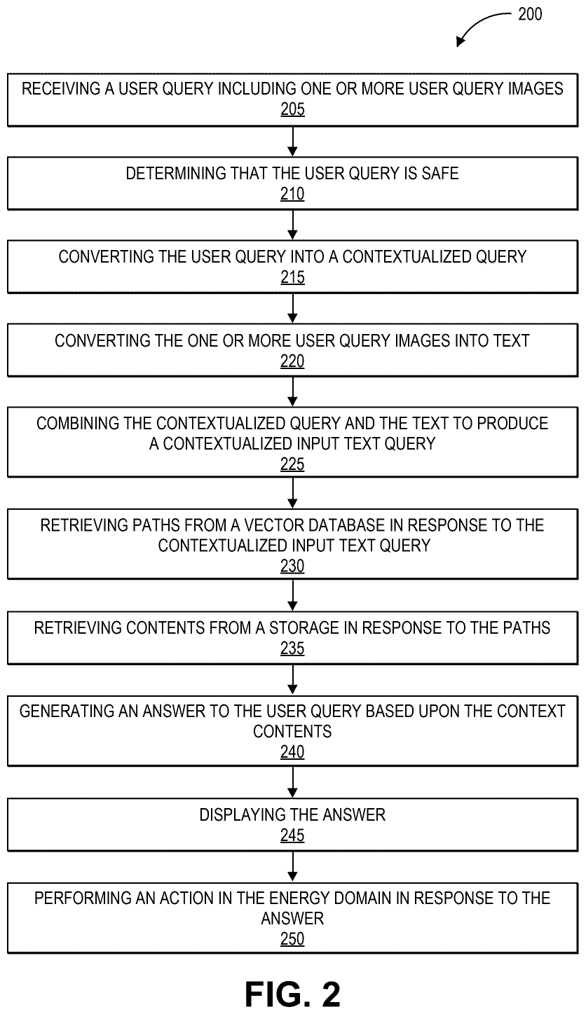

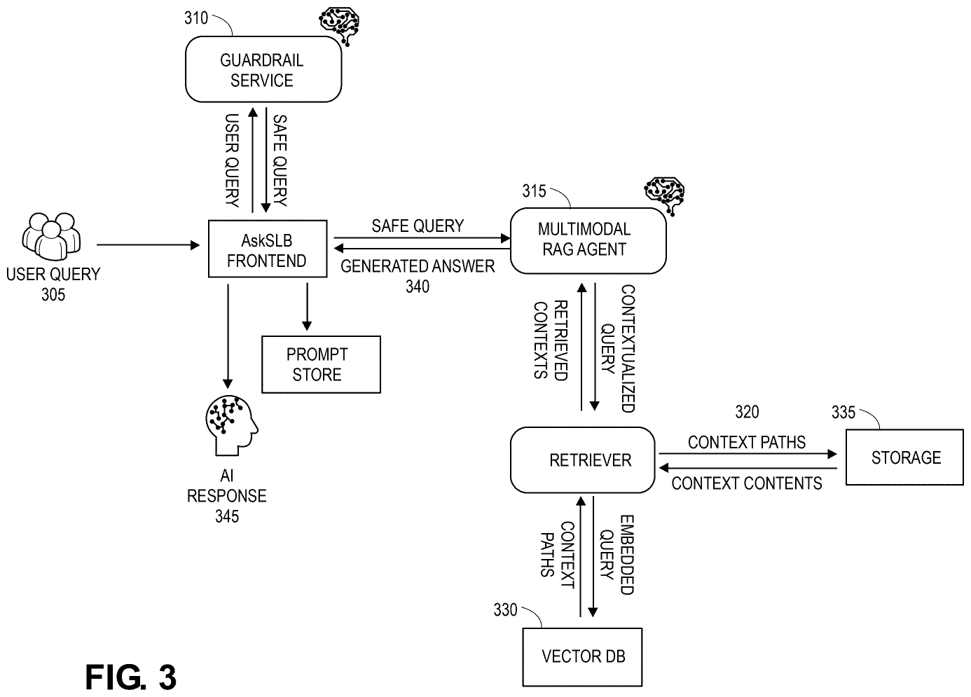

FIG. 2 illustrates a flowchart of a method 200 for generating a response to a user query, and FIG. 3 illustrates a schematic view of the method 200, according to an embodiment. An illustrative order of the method 200 is provided below; however, one or more portions of the method 200 may be performed in a different order, simultaneously, repeated, or omitted. At least a portion of the method 200 may be performed using a computing system.

The method 200 includes receiving a user query, as at 205. This is also shown at 305 in FIG. 3. The user query may involve user query text and/or one or more user query images. The user query may be related to an energy domain (e.g., oil and gas). In an example, the user query may be “How do I set the zone settings for facies modelling in Petrel?”

The method 200 may also include determining that the user query is safe, as at 210. This is also shown at 310 in FIG. 3. The determination may be made using a guardrail service.

The method 200 may also include converting the user query into a contextualized query, as at 215. This is also shown at 315 in FIG. 3. The conversion may be performed using a multimodal retrieval-augmented generation (RAG) agent. In an example, the contextualized query may be “How do I set the zone settings for facies modelling in Petrel?”

The method 200 may also include converting the one or more user query images into text, as at 220. The conversion may be performed using a large language model (LLM) or a custom vision language model (VLM).

The method 200 may also include combining the contextualized query and the text to produce a contextualized input text query, as at 225. In an example, the contextualized input text query may be “How do I set the zone settings for Facies modelling in Petrel?”

The method 200 may also include retrieving paths from a vector database in response to the contextualized input text query, as at 230. This is also shown at 330 in FIG. 3. The paths may include context paths of documents that are retrieved from a first portion of the vector database and/or image paths that are retrieved from a second portion of the vector database. In an embodiment, content for determining the image paths may be created based upon documents in the vector database. The documents may include one or more document images. The content for determining the image paths may be created based upon (1) text before and/or after one or more document images, (2) a caption corresponding to the one or more document images, and/or (3) a description of the one or more document images determined by a multimodal model.

In an example, the paths may be:

[“processed_slb_product_documentation_V2/slb_product_documentation/Subsurface_zip/Subsu rface/Petrel/Help/XML/Publish-Petrel-2024-04-9-121418_zip/Petrel/Make_model_tab_settings_Petrophysical_modeling_D19806DC-6DF1-42D-A3B1-C6B1FE04EEAF.md”,
“processed_slb_product_documentation_V2/slb_product_documentation/Subsurface_zip/Subsur face/Petrel/Help/XML/Publish-Petrel-2024-04-19-121418_zip/Petrel/As_for_the_zone_above_Petrophysical_modeling_721A8F46-C7DC-4253 -8740-57C3C7ABD9F1.md”,
“processed_slb_product_documentation_V2/slb_product_documentation/Subsurface_zip/Subsur face/Petrel/Help/XML/Publish-Petrel-2024-04-19 -121418_zip/Petrel/Stochastic_facies_modeling_1CB91CB3-D491-4B34-A589 -2B198827D540.md”,
“processed_slb_product_documentation_V2/slb_product_documentation/Subsurface_zip/Subsur face/Petrel/Training/XML/Getting_Started_with_Petrel_2022_Edition_zip/Getting_Started_with _Petrel_2022_Edition/Project_settings_05360A2B-429E-424E-B0DC-94494AFAEFF8.md”, “processed_slb_product_documentation_V2/slb_product_documentation/Subsurface_zip/Subsur face/Petrel/Training/XML/Petrel_Geostatistics_zip/Petrel_Geostatistics/Run_a_variogram_analy sis_A5DB0AD8-3D53-4C60-8587-25ABB73C6E01.md”]

In an example, the image paths may be:

[‘processed_slb_product_documentation_V2/slb_product_documentation/Subsurface_zip/Subsur face/Petrel/Help/XML/Publish-Petrel-2024-04-19-121418_zip/Petrel/b8ca3a85533b-a8edf99e-fdc4-4856-bf02-bee99b7976f1_7_2225C1ED-C45C-4769-992A-F4DC12494D79.png’, ‘processed_slb_product_documentation_V2/slb_product_documentation/Subsurface_zip/Subsurf acc/Petrel/Help/XML/Publish-Petrel-2024-04-19-121418_zip/Petrel/b8ca3a85533b-a8edf99e-fdc4-4856-bf02-bee99b7976f1_19_2C3AB090-9623-4682-9159-E08F4BF7555A.png’, ‘processed_slb_product_documentation_V2/slb_product_documentation/Subsurface_zip/Subsurf ace/Petrel/Help/XML/Publish-Petrel-2024-04-19-121418_zip/Petrel/b8ca3a85533b-a8edf99e-fdc4-4856-bf02-bee99b7976f1_6_022351E4-AF27-4AD9-8FFE-4C22D0F9BD97.png’]

The method 200 may also include retrieving contents from a storage in response to the paths, as at 235. This is also shown at 335 in FIG. 3. The content may include context contents that are retrieved from a first portion of the storage and/or image contents that are retrieved from a second portion of the storage in response to the contextualized input text query. The context contents may include information related to the user query including a user manual training manuals and/or a user guide.

The method 200 may also include generating an answer to the user query based upon the context contents, as at 240. This is also shown at 340 in FIG. 3. The answer may be generated using the multimodal RAG agent.

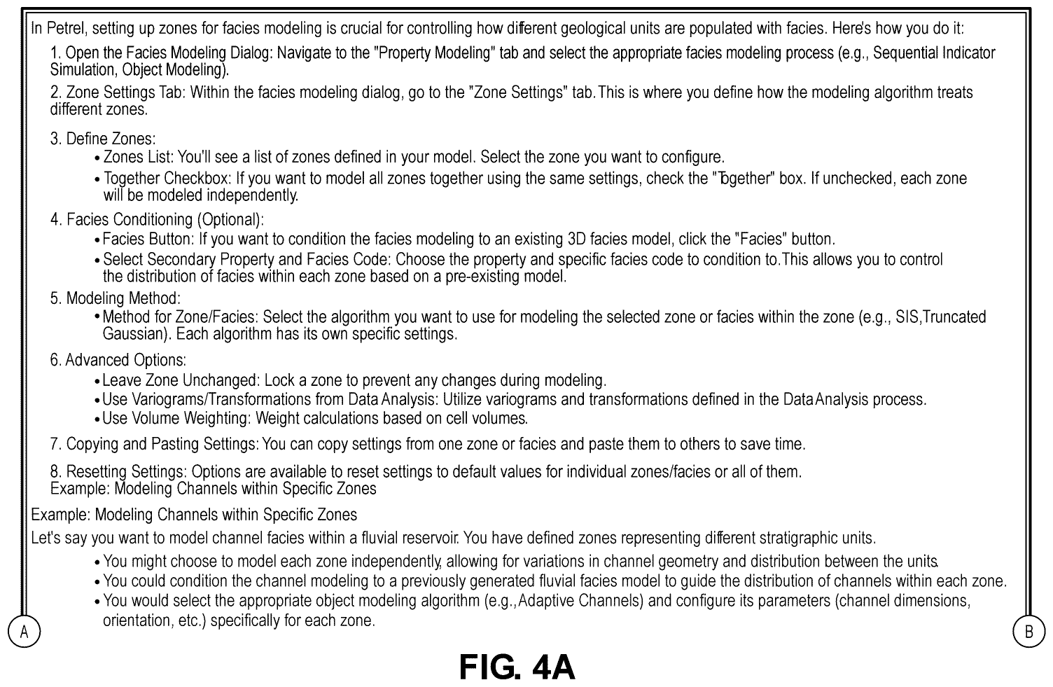

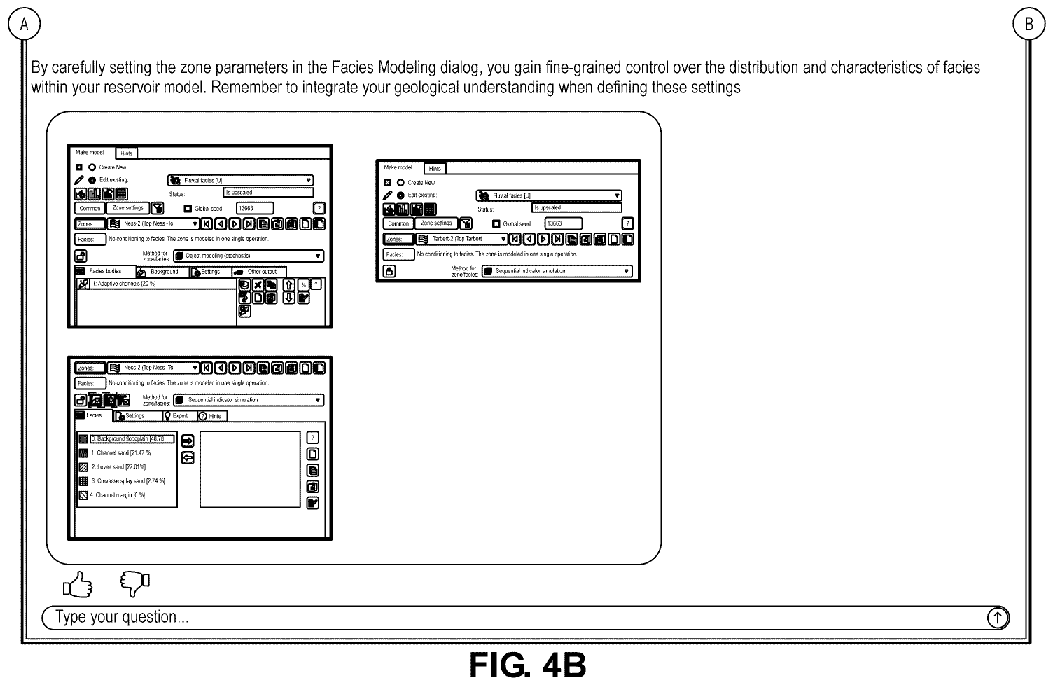

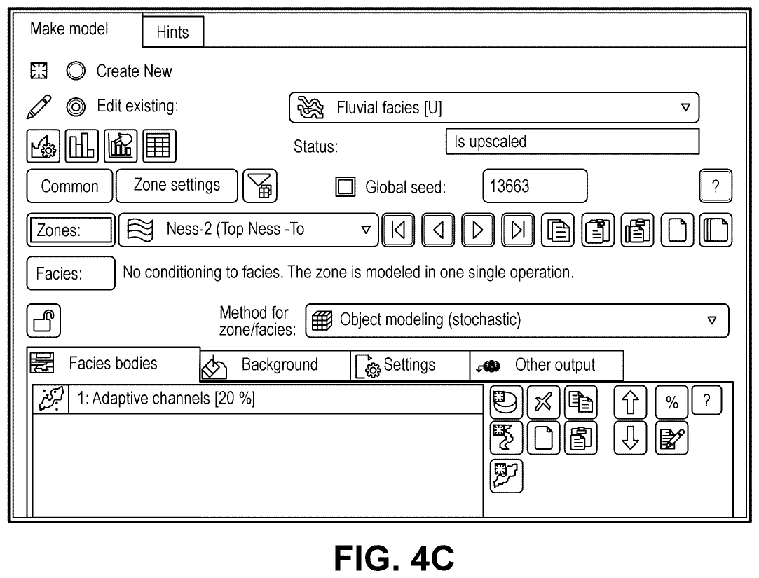

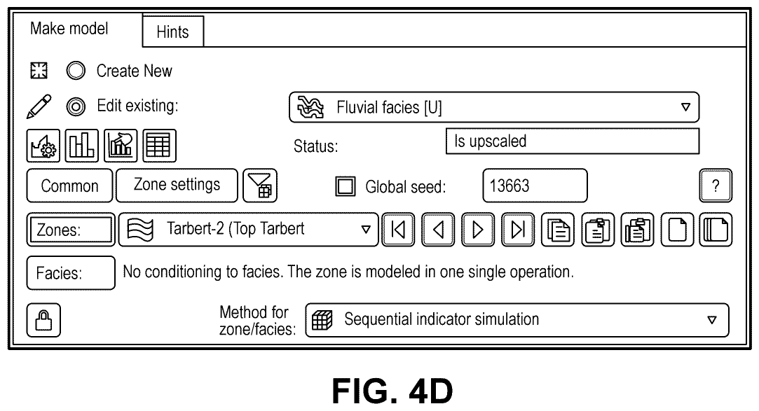

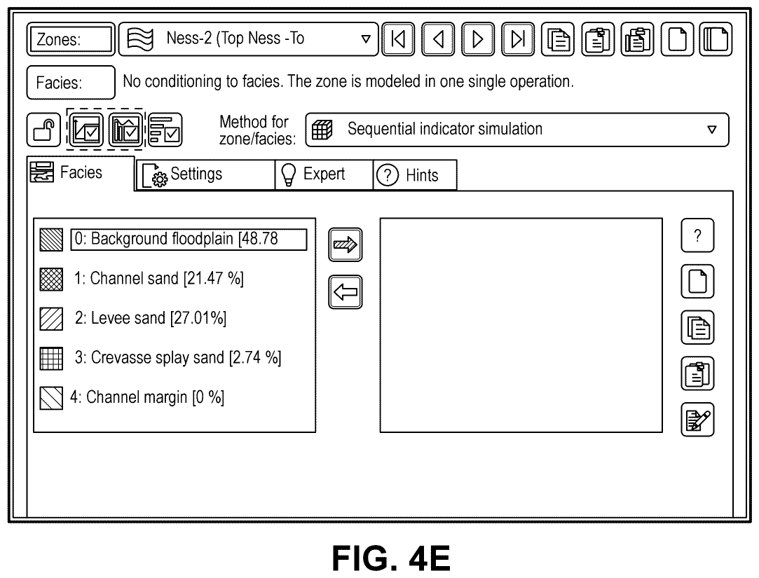

The method 200 may also include displaying the answer, as at 245. This is also shown at 345 in FIG. 3. FIGS. 4A-4E illustrate an example of the answer to the user query “How do I set the zone settings for facies modelling in Petrel?”

The method 200 may also include performing an action in the energy domain in response to the answer, as at 250. The action may be or include generating and/or transmitting a signal (e.g., using a computing system) that recommends, instructs, or causes a physical action to occur (e.g., at a wellsite and/or facility). The action may also or instead include performing the physical action. The physical action may include selecting where to drill a wellbore, drilling the wellbore, varying a weight and/or torque on a drill bit that is drilling the wellbore, varying a drilling trajectory of the wellbore, varying a concentration and/or flow rate of a fluid pumped into the wellbore, or the like.

### Exemplary Computing System

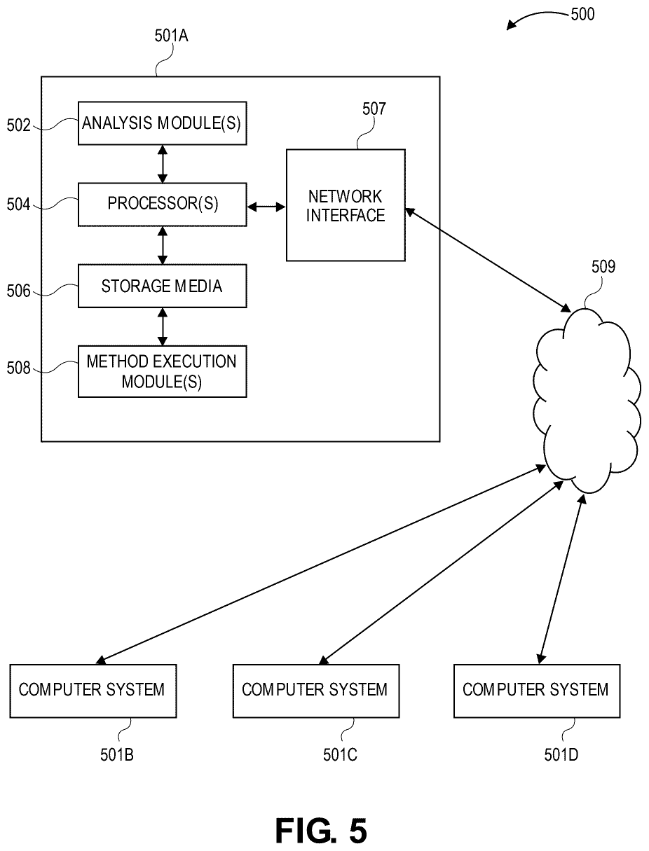

In some embodiments, the methods of the present disclosure may be executed by a computing system. FIG. 5 illustrates an example of such a computing system 500, in accordance with some embodiments. The computing system 500 may include a computer or computer system 501A, which may be an individual computer system 501A or an arrangement of distributed computer systems. The computer system 501A includes one or more analysis modules 502 that are configured to perform various tasks according to some embodiments, such as one or more methods disclosed herein. To perform these various tasks, the analysis module 502 executes independently, or in coordination with, one or more processors 504, which is (or are) connected to one or more storage media 506. The processor(s) 504 is (or are) also connected to a network interface 507 to allow the computer system 501A to communicate over a data network 509 with one or more additional computer systems and/or computing systems, such as 501B, 501C, and/or 501D (note that computer systems 501B, 501C and/or 501D may or may not share the same architecture as computer system 501A, and may be located in different physical locations, e.g., computer systems 501A and 501B may be located in a processing facility, while in communication with one or more computer systems such as 501C and/or 501D that are located in one or more data centers, and/or located in varying countries on different continents).

A processor may include a microprocessor, microcontroller, processor module or subsystem, programmable integrated circuit, programmable gate array, or another control or computing device.

The storage media 506 may be implemented as one or more computer-readable or machine-readable storage media. Note that while in the example embodiment of FIG. 5 storage media 506 is depicted as within computer system 501A, in some embodiments, storage media 506 may be distributed within and/or across multiple internal and/or external enclosures of computing system 501A and/or additional computing systems. Storage media 506 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 500 contains one or more method execution module(s) 508. In the example of computing system 500, computer system 501A includes the method execution module 508. In some embodiments, a single method execution module may be used to perform some aspects of one or more embodiments of the methods disclosed herein. In other embodiments, a plurality of method execution modules may be used to perform some aspects of methods herein.

It should be appreciated that computing system 500 is merely one example of a computing system, and that computing system 500 may have more or fewer components than shown, may combine additional components not depicted in the example embodiment of FIG. 5, and/or computing system 500 may have a different configuration or arrangement of the components depicted in FIG. 5. The various components shown in FIG. 5 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 500, FIG. 5), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for generating a response to a user query, the method comprising:
receiving a user query, wherein the user query involves user query text and/or one or more user query images;
converting the user query into a contextualized query using a multimodal retrieval-augmented generation (RAG) agent;
retrieving paths from a vector database in response to the contextualized query;
retrieving contents from a storage in response to the paths; and
generating an answer to the user query based upon the contents.

2. The method of claim 1, wherein the user query is related to an energy domain.

3. The method of claim 1, further comprising converting the one or more user query images into text using a large language model (LLM) or a custom vision language model (VLM), wherein the paths are retrieved at least partially in response to the text.

4. The method of claim 3, further comprising combining the contextualized query and the text to produce a contextualized input text query, wherein the paths are retrieved in response to the contextualized input text query.

5. The method of claim 4, wherein the content comprises context contents that are retrieved from a first portion of the storage and image contents that are retrieved from a second portion of the storage in response to the contextualized input text query.

6. The method of claim 1, wherein the paths comprise context paths of documents that are retrieved from a first portion of the vector database and image paths that are retrieved from a second portion of the vector database.

7. The method of claim 6, wherein the context contents comprise information related to the user query including a user manual training manuals and a user guide.

8. The method of claim 1, wherein the answer is generated using the multimodal RAG agent.

9. The method of claim 1, further comprising displaying the answer.

10. The method of claim 1, further comprising performing a physical action in response to the answer.

11. A computing system, comprising:
one or more processors; and
a memory system comprising one or more non-transitory computer-readable media storing instructions that, when executed by at least one of the one or more processors, cause the computing system to perform operations, the operations comprising:
receiving a user query, wherein the user query involves user query text and/or one or more user query images, and wherein the user query is related to an energy domain;
converting the user query into a contextualized query using a multimodal retrieval-augmented generation (RAG) agent;
converting the one or more user query images into text using a large language model (LLM) or a custom vision language model (VLM);
combining the contextualized query and the text to produce a contextualized input text query;
retrieving paths from a vector database in response to the contextualized input text query, wherein the paths comprise context paths of documents that are retrieved from a first portion of the vector database and/or image paths that are retrieved from a second portion of the vector database;
retrieving contents from a storage in response to the paths, wherein the content comprises context contents that are retrieved from a first portion of the storage and/or image contents that are retrieved from a second portion of the storage in response to the contextualized input text query, and wherein the context contents comprise information related to the user query; and
generating an answer to the user query based upon the contents, wherein the answer is generated using the multimodal RAG agent.

12. The computing system of claim 11, wherein the operations further comprise determining that the user query is safe using a guardrail service.

13. The computing system of claim 11, wherein content for determining the image paths is created based upon documents in the vector database.

14. The computing system of claim 13, wherein the documents comprise one or more document images.

15. The computing system of claim 14, wherein the content for determining the image paths is created based upon:
text before and/or after one or more document images;
a caption corresponding to the one or more document images; and/or a description of the one or more document images determined by a multimodal model

16. A non-transitory computer-readable medium storing instructions that, when executed by one or more processors of a computing system, cause the computing system to perform operations, the operations comprising:
receiving a user query, wherein the user query involves user query text and one or more user query images, and wherein the user query is related to an energy domain;
determining that the user query is safe using a guardrail service;
converting the user query into a contextualized query using a multimodal retrieval-augmented generation (RAG) agent;
converting the one or more user query images into text using a large language model (LLM) or a custom vision language model (VLM);
combining the contextualized query and the text to produce a contextualized input text query;
retrieving paths from a vector database in response to the contextualized input text query, wherein the paths comprise context paths of documents that are retrieved from a first portion of the vector database and image paths that are retrieved from a second portion of the vector database, wherein content for determining the image paths is created based upon documents in the vector database, wherein the documents comprise one or more document images, and wherein the content for determining the image paths is created based upon:
text before and after one or more document images;
a caption corresponding to the one or more document images; and
a description of the one or more document images determined by a multimodal model;
retrieving contents from a storage in response to the paths, wherein the content comprises context contents that are retrieved from a first portion of the storage and image contents that are retrieved from a second portion of the storage in response to the contextualized input text query, and wherein the context contents comprise information related to the user query including a user manual training manuals and a user guide; and
generating an answer to the user query based upon the contents, wherein the answer is generated using the multimodal RAG agent.

17. The non-transitory computer-readable medium of claim 16, wherein the operations further comprise displaying the answer.

18. The non-transitory computer-readable medium of claim 16, wherein the operations further comprise performing an action in the energy domain in response to the answer

19. The non-transitory computer-readable medium of claim 18, wherein the action comprises generating or transmitting a signal that recommends, instructs, or causes a physical action to occur.

20. The non-transitory computer-readable medium of claim 19, wherein the physical action comprises drilling a wellbore, varying a weight and/or torque on a drill bit that is drilling the wellbore, varying a drilling trajectory of the wellbore, varying a concentration and/or flow rate of a fluid pumped into the wellbore, or a combination thereof.
